(19) United States
(12) Patent Application Publication
(10) Pub. No.: US 2024/0411918 A1
(43) Pub. Date: Dec. 12, 2024

(54) EDGE-BASED ACCESS CONTROL FOR DATA QUERIES

(71) Applicant: Inigo Labs, Inc., Palo Alto, CA (US)

(72) Inventors: Eitan Joffe, Palo Alto, CA (US); Shachar Binyamin, Mountain View, CA (US)

(21) Appl. No.: 18/679,119

(22) Filed: May 30, 2024

Related U.S. Application Data
(60) Provisional application No. 63/471,456, filed on Jun. 6, 2023.

(51) Int. Cl. G06F 21/62

(52) U.S. Cl. CPC G06F 21/6227

(57) ABSTRACT

The application relates to edge-based access control for data queries. In one embodiment, a processing device receives, from a user device, a request comprising a query for data stored on a server. The request is associated with a user profile. The processing device identifies a part of the query. The identified part of the query is associated with an access path. Based on a rule associated with the user profile, the processing device determines whether the access path is valid. Responsive to determining that the access path is valid, the processing device removes the part of the query from the request, and sends, to the user device, an indication that the access path is not valid.

### RELATED APPLICATIONS

This application is related to and claims the benefit of U.S. Provisional Patent Application No. 63/471,456, filed Jun. 6, 2023, titled “Edge-Based Access Control For Data Queries,” the entirety of which is incorporated herein by reference.

### TECHNICAL FIELD

This disclosure relates to the field of access control for data queries, and more particularly, to edge-based access control for GraphQL®.

### BACKGROUND

Access control for data queries can be used to control access to data that is being queried by a user and/or by an application. Access control can be an important aspect of data security, and can help prevent unauthorized access to data, data breaches, and other security incidents.

### BRIEF DESCRIPTION OF THE DRAWINGS

The present disclosure will be understood more fully from the detailed description given below and from the accompanying drawings of various embodiments of the present disclosure, which, however, should not be taken to limit the present disclosure to the specific embodiments, but are for explanation and understanding only.

FIG. 1 is a block diagram illustrating an example network architecture operating in accordance with embodiments of the present disclosure.

FIG. 2 is a block diagram illustrating an example computer system, in accordance with embodiments of the present disclosure.

FIG. 3 is a block diagram illustrating a request processing system, in accordance with embodiments of the present disclosure.

FIG. 4 is a flow diagram illustrating a method for edge-based access control, in accordance with embodiments of the present disclosure.

FIG. 5 is a block diagram of an example computing device in which embodiments of the present disclosure may operate.

### DETAILED DESCRIPTION

Embodiments are described with regards to edge-based access control for data queries. Some embodiments, in particular, are directed to implementing access control for GraphQL and/or other query languages that permit complex queries that can return large quantities of data responsive to a single query. Access control refers to controlling access to data that is being queried (or accessed) by an application or a user (i.e., a requestor). Accessing data can include reading, writing, and/or modifying the data. Implementing access control security measures can help ensure that access to certain data is limited to authorized requestors.

Conventional access control security measures can apply a rule to a particular data object stored in a data store. The rule can place access restrictions on the object based on, for example, a credential of the user requesting access to the object. For example, conventional access control restrictions can limit access to sensitive data (e.g., social security number) to requestors categorizes as administrators.

GraphQL is a data query and manipulation language for application programming interfaces (APIs) that enables users to request exactly the data they need in a single request. GraphQL provides a complete description of the data accessible by an API. A backend developer can develop a schema for data, which enables front-end users of the API to explore and request specific data. A schema is a blueprint for defining the types of data that can be queried and manipulated in an API. The schema defines the available fields and types of objects that can be requested, as well as the relationships between these objects. For example, developers can define the types of objects in their schema, the fields of each object type, the arguments that can be passed to each field, and the types of the data that are returned. A developer can add a directive to the schema to limit access to a particular part (e.g., an object) of the schema. A directive is an identifier that can be attached to a field or fragment, which can affect the execution of the query. The directive can specify a rule that the server applies to the field or fragment in the schema. Thus, conventional access control for GraphQL can be implemented using a directive. For example, a directive can place a rule on a particular field, specifying that only requestors of a specific type can access the particular field.

However, GraphQL queries (and queries for other similar query languages) can access data using a variety of paths. A path (or data path) refers to the path that is followed to access a specific piece of data from a server. A data path is the sequence of fields and relationships that are traversed to reach a particular data point. A data path can represent the relationship between objects. Conventional access restrictions placed on a particular field or fragment (e.g., using a directive) cannot accommodate access restrictions that vary based on the path in which the requested data is accessed in the query. Accordingly, conventional access control that place restrictions on a field or fragment in a schema provide limited data protection.

Aspects of the present disclosure address the above-noted and other deficiencies by implementing edge-based access control based on the content of the query by contextualizing the request. As described in embodiments of the present disclosure, edge-based access control can place restrictions on the path in which data is requested. Some data models are organized in a graph-like structure. The nodes of the graph represent objects or entities, while the edges represent the relationships between those objects. Each node in the graph can correspond to a specific data object, and each edge can represent a specific relationship between those objects. Query languages (such as graphQL) enable users to query the graph-like structure by specifying the a requested field and the path to traverse to reach the field. Edge-based access control provides access restrictions based on the data path (i.e., the edges of the graph-like structure) of the requested object rather than based on the object. Thus, the access control limitations correlate to the query, rather than to the schema.

In some embodiments, edge-based access control can be implemented on a client server. Each client can establish a set of rules for implementing access control on requests received from user devices. The rules can set access restrictions at a variety of granularities associated with a request. A rule can be based on the type of data requested. A rule (or a set of rules) can be specific for each user profile of the requestor, and/or for groups of user profiles (e.g., associated with a role of the user). Multiple rules can be applied to one query. A configuration component can configure access control rules according to a client's input.

The client server can implement an access control component using the access control rules received from the configuration component. The access control component can receive a request, which includes a query, from a user device connected to the client server. The access control component can parse the query in the received request to identify parts of the query. A part of a query can be, for example, a requested data object and/or the data path associated with the requested data object. In some embodiments, the part of the query can include an input parameter that modifies the data object. The access control component can identify the access control rule(s) applicable to the request (e.g., based on the user profile or user ID), and can compare the identified parts to the rules applicable to the request. The access control component can then identify the part(s) of the query that are accessible to the user device, and process the accessible parts of the query while blocking the inaccessible parts of the query.

In some embodiments, the access control component can determine that the query as a whole is accessible to the requestor and can enable the query to be processed by the server. In some implementations, the access control component can determine that a part (or parts) of the query is inaccessible to the requestor based on access control rules. The access control component can enable the parts of that query that are accessible to the user to be processed by the server, while blocking the parts of the query that are inaccessible to the user to be processed by the server. The access control component can store information describing the inaccessible part(s) of the query, such as a reason why each corresponding part is inaccessible. In some embodiments, the access control component can then generate a second query that includes the part(s) that are accessible to the requestor. The server can then process, and generate a response to, the query that the access control component has deemed accessible to the requestor. In some embodiments, the access control component can send a notification to the requestor indicating which part(s) of the request are inaccessible to the requestor. In some embodiments, the access control component can add the error notification to the response generated by the server.

Advantages of the present disclosure include, but are not limited to, improved security and data protection for servers using APIs for query languages, such as GraphQL APIs. Aspects of the present disclosure provide such data protection for APIs (e.g., GraphQL APIs) by implementing access control based on the content of the query, rather than based on the schema as a whole. By implementing the access control component on the client's server device, aspects of the present disclosure provide for low latency and high throughput of requests fulfilled by the client's server device. The access control described herein provides enhanced data protection by contextualizing the request and applying access control rules to the content of the query, rather than on the schema as a whole.

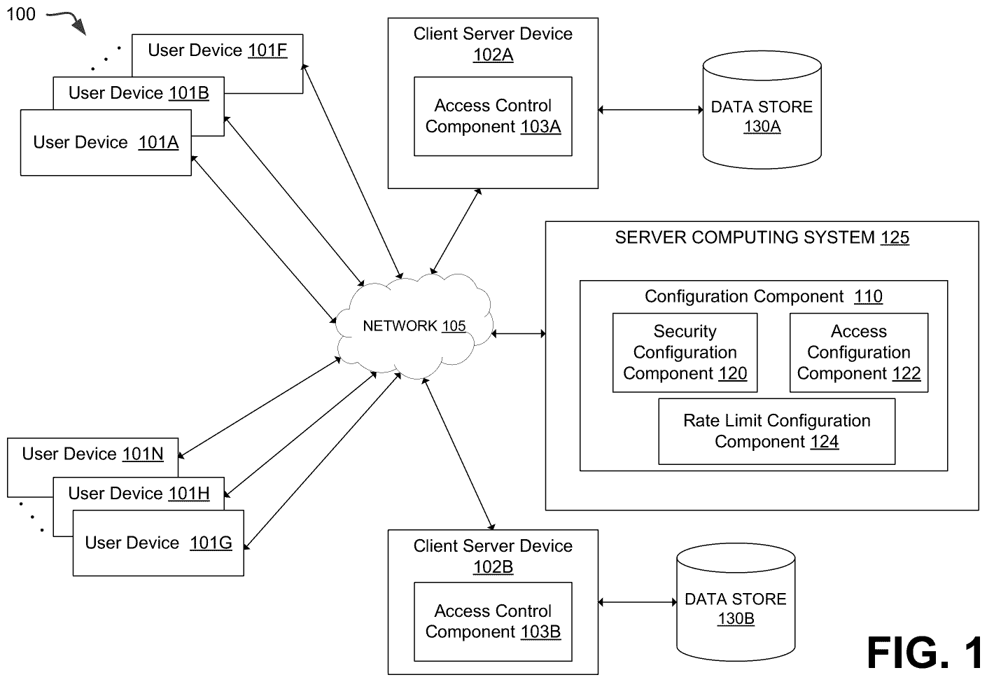

FIG. 1 is a block diagram illustrating an example network architecture 100, in accordance with embodiments of the present disclosure. The network architecture 100 includes one or more user devices 101A-N connected to one or more client server devices 102A-B and/or to one or more server computing systems 125 via a network 105. In some embodiments, user devices 101A-F can connect to client server device 102A, and user devices 101G-N can connect to client server device 102B. In some embodiments, the user devices 101A-N can be connected to client server devices 102A,B directly, and/or via networks different from network 105. Examples of user devices 101A-N can include computing devices (e.g., desktop computers, laptop computers), and/or mobile devices (e.g., mobile phones, tablets), or other computing devices. In some embodiments, server computing system 125 and/or client server devices 102A-B can operate in a cloud environment.

In embodiments, network 105 can include a wide area network (WAN), which can be a private WAN (e.g., an intranet) or a public WAN such as the Internet, or may include a combination of a private and public network. In some embodiments, network 105 can include a local area network (LAN), which can include a router, switch, bridge, or other network device (not shown) that enables communication between multiple devices connected to the LAN. The network device can provide wired connections to the LAN using, for example, Ethernet ports, universal serial bus (USB) ports and/or Firewire® ports. The network device may additionally provide wireless connections to the LAN using, for example, a Wi-Fi transceiver.

Client server devices 102A-B can be connected to a server computing system 125 via network 105. In some embodiments, client server devices 102A-B can be connected to server computing system 125 via a network other than network 105, and/or can be connected directly to configuration component 110. Client server devices 102A-B can also include, or be connected to, a data store 130A-B. Data store 130A,B can each store data associated with the corresponding client server device 102A,B. User devices 101A-N can send queries to client server devices 102A,B to request access to data stored in data stores 130A,B.

Client server devices 102A-B, and/or server computing system 125, can each include a physical machine and/or a virtual machine hosted by a physical machine. The physical machine can be a rackmount server, a desktop computer, or other computing device. In one embodiment, the client server devices 102A-B and/or server computing system 125 can include a virtual machine managed and provided by a cloud provider system. Each virtual machine offered by a cloud service provider may be hosted on a physical machine configured as part of a cloud. Such physical machines are often located in a data center. The cloud provider system and cloud may be provided as an infrastructure as a service (IaaS) layer. The client server devices 102A-B can host an access control component 103A-B. The server computing system 125 can host a configuration component 110.

Configuration component 110 can include a security configuration component 120, an access configuration component 122, and/or a rate limit configuration component 124. Configuration component 110 can configure security, access control, and/or rate limit rules. Configuration component 110 can configure the rules based on input received from a client (e.g., from client server device 102A,B), and/or based on metrics associated with processing requests by a client (e.g., client server device 102A,B). The metrics can include, for example, the time and/or resources consumed while processing requests to generate responses. The rate limit rules can limit the number of and/or frequency of queries sent from a user device 101A-N based on the content of the request. The access control rules can place limits on how certain data fields or data objects can be accessed, and/or which user roles have access to certain data fields in data stores 130A,B, e.g., based on the data path traversed to access the data field or object. The security rules can implement certain security features to protect data stored on data stores 130A,B, and/or to protect client server devices 102A,B from over-use or abuse by a client device 101A-N. The configuration component 110 can send the configured rules to the client server device 102A,B.

The access configuration component 122 can configure access control rules for each client server device 102A,B. The access control rules can be based on input from the client server device 102A,B. The input from the client server device 102A,B can include rules for different profiles of users. The access control rules can restrict access to certain data objects based on the data path of the requested object. Accessing a data object can includes reading, writing, and/or modifying data. For example, an access control rule can limit who can read an object accessed via a certain data path; another access control rule can limit who can modify data by placing a rule on who can provide an input parameter of an object. In some embodiments, the rules sent by client server device 102A,B can be assigned to a number of roles. Users of user device 101A-G can be assigned to a role (or in some instances, to multiple roles). The access configuration component 122 can configure the rules received from client server device 102A,B, and can create access control policies for each role for each client server device 102A,B. The access configuration component 122 can then send the access control policies for each role to the corresponding access control component 103A,B. Note that in some embodiments, the access control policies can be based on input received from a client server device other than client server device 102A,B, and/or from another source.

Access control component 103A,B can apply the access control policies received from configuration component 110. In some embodiments, the policies can each include a number of access control rules for each user role. Access control component 103A,B can apply the access control policies on a request received from a user device 101A-N. Imposing access control policies can include identifying the access control policy that corresponds to the role of the user of user device 101A-N from which the request was received. In some embodiments, the user can have a user profile and/or a user ID that the access control component 103A,B can use to identify the correct access control policy. The access control component 103A,B can parse the request into a format that can be mapped to the rules received from configuration component 110. That is, by parsing the request, the access control component 103A,B can identify the different parts of the query. The parts of the query can be the requested data objects and their corresponding data paths. The access control component 103A,B can then identify the rule in the policy that corresponds to the data path of the requested data object, and can determine whether access control policy enables access to the data object that is being requested via the data path. If the access control policy enables access, the access control component 103A,B can allow that part of the query to be processed by the server. If the access control policy does not enable access, the access control component 103A,B can determine that the identified part of the query is invalid.

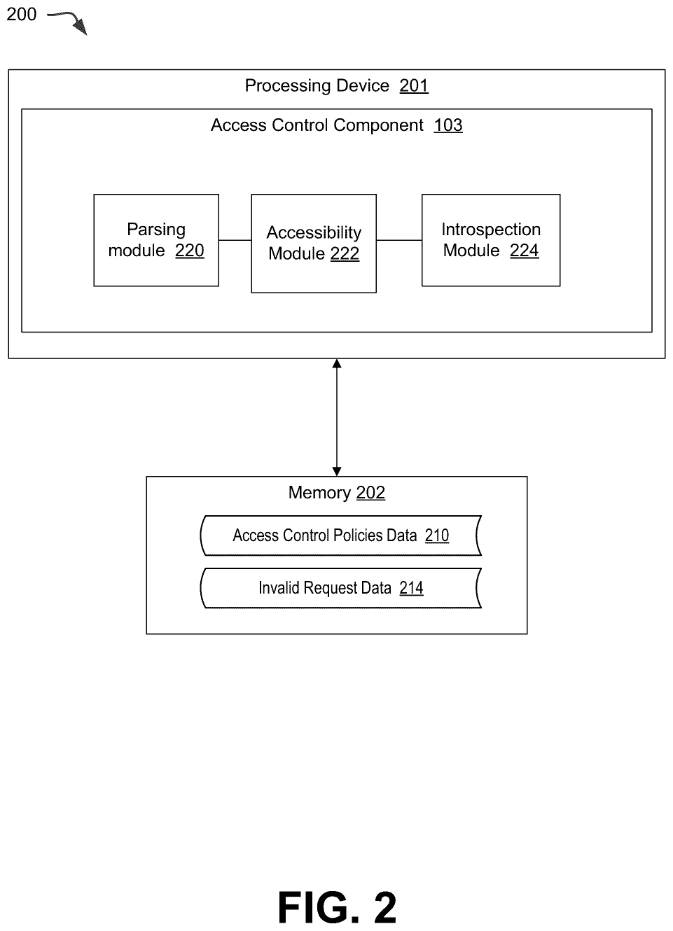

In some embodiments, the access control component 103A,B can block the invalid part(s) of the query from being processed by the server. In some embodiments, the access control component 103A,B can generate a second query that includes only the valid part(s) of the received query, and the client server device 102A,B can process the second query. The client server device 102A,B can return a response, which can be sent to the corresponding user device 101A-G. In some embodiments, the access control component 103A,B can append an error message to the response prior to sending the response to the corresponding user device 101A-G. In some embodiments, the access control component 103A,B can issue a separate error notification to the user device 101A-G indicating which part(s) of the query were determined to be invalid according to the access control policy (or policies) for the user. Access control component 103A,B is further described with respect to FIG. 2.

FIG. 2 depicts a block diagram illustrating a computer system 200, operating in accordance with one or more aspects of the present disclosure. Computer system 200 may be the same as or similar to server device 102A,B of FIG. 1. Computer system 200 can include an access control component 103, and a memory 202 that can store access control policies data 210, and/or invalid request data 214. Access control policies data 210 can store configured access control policies associated with a specific user, a profile (which can be associated with a user role), an IP address, a user device, or any other level of granularity. The policies stored in access control policies data 210 can each include a number of rules placed on the data access paths associated with data objects. The invalid request data 214 can store indications of which part(s) of received requests are determined to be invalid based on the corresponding access control policy.

As an illustrative example, the access control policies data 210 can be a data structure (e.g., a list or a table) of rules for various levels of granularity of data queries. Levels of granularity can correspond to different parts of the query. For example, the levels of granularity can correspond to a certain data path accessing a data field, and thus access control policies data 210 can include a rule for each of the data paths. The access control policies data 210 can correspond to a role of a user. In some embodiments, an access control policy in 210 can correspond to multiple user roles.

The access control component 103 can perform the same functions as access control component 103A-B, as illustrated in FIG. 1. The access control component 103 can include a parsing module 220, an accessibility module 222, and/or an introspection module 224. In embodiments, each of the modules may be or include logic configured to perform a particular action or set of actions. In embodiments, one or more of the modules may be combined into a single module. In embodiments, the functions of one or more modules may be divided into sub-modules.

In embodiments, the parsing module 220 can enable a processor to parse a query received in a request for data from a user device (e.g., user device 101A-N of FIG. 1). The parsing module 220 can access the query in the request and identify parts of the query. The parts of the query identified by the parsing module 220 can include different types of data requested in the query, different fields requested in the query, the number of each type of data and/or field requested in the query, and/or a path of the data requested in the query. In some embodiments, the parsing module 220 can parse the query into an abstract syntax tree. The nodes in the tree can represent the various data objects, and the edges of the tree can represent the relationships between the data objects. The edges of the tree that lead to the requested data path can have a corresponding rule stored in access control policies data 210. That is, the parts of the query can correspond to rules in access control policies data 210.

In embodiments, the accessibility module 222 can enable a processor to identify the access control policy (or policies) in access control policies data 210 that correspond to received request. For example, the request can include a user ID, user profile, and/or user role. The accessibility module 222 can identify the access control policies that correspond to the request. The accessibility module 222 can then compare the identified access control policy (or policies) to the identified part(s) of the query from parsing module 220. The accessibility module 222 can determine whether the identified part(s) are accessible to the requestor.

For example, the access control policy for the role associated with the request can enable access to a particular data object if it is accessed using one data path, but can disable access to the some data object if it is accessed using another data path. As another example, the access control policy can limit the input parameters for a data object. The accessibility module 222 can compare the part (i.e., the data path) of the query identified by parsing module 220 to the access control policy corresponding to the requestor to determine whether the part is valid.

If the identified part is invalid, the accessibility module 222 can enable a processor to store an indication in invalid request data 214. For example, the accessibility module 222 can store the invalid data path, or an indication of the invalid data path, in invalid request data 214. The accessibility module 222 can then send the valid parts of the query to the processing device 201 to be processed. In some embodiments, the accessibility module 222 can send an indication of the invalid part(s) to the user device from which the request was received. In some embodiments, the accessibility module 222 can append an indication of the invalid part(s) to the response of the request, prior to the response being sent to the user device from which the request was received.

In some embodiments, the introspection module 224 can enable a processor to receive an introspection request to view data stored on the server. Introspection is the ability of a server to query and describe its own schema and the types it supports. Introspection enables a user to discover what data can be queried, and what types of data can be expected in a response. The introspection module 224 can identify the role associated with the requestor (e.g., associated with the user device from which the request is received), and can identify an access control policy (or policies) in access control policy data 210 that corresponds to the role. The introspection module 224 can then determine which data and data paths are accessible under the access control policy, and can provide the accessible data and data paths to the user device. The user device can in turn display the accessible data and data paths, thus enabling the user to view what data and data paths are valid. The introspection module 224 enables a user to dynamically explore and understand the schema without required manual documentation or hardcoded assumptions about the API's capabilities.

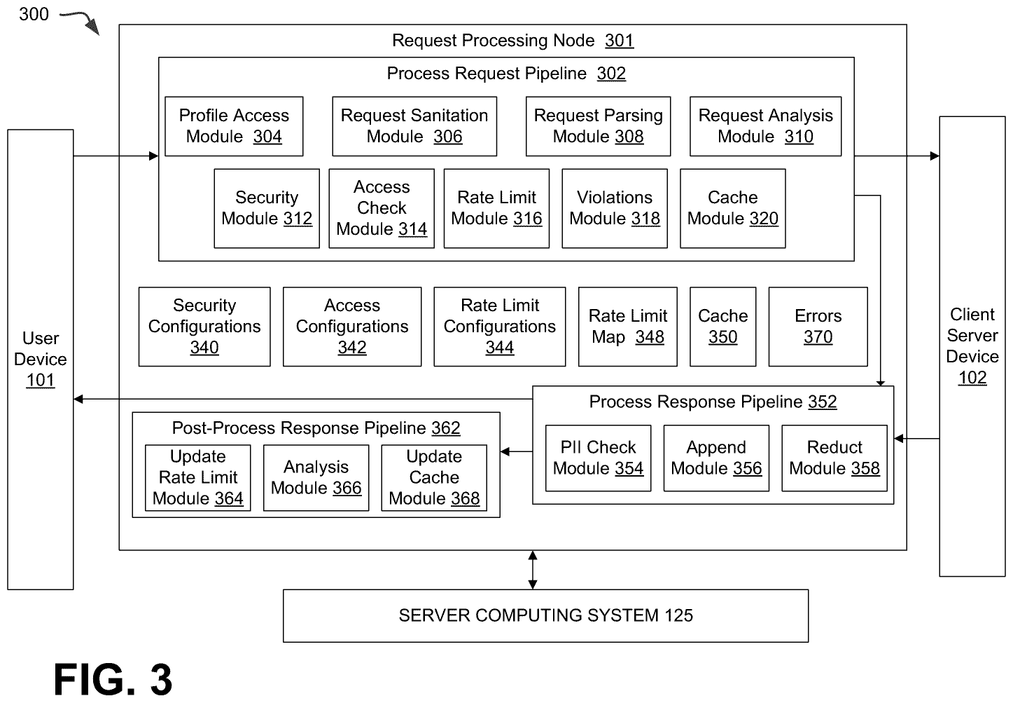

FIG. 3 is a block diagram illustrating a request processing system 300, in accordance with embodiments of the present disclosure. The request processing system 300 can include a request processing node 301 coupled to a user device 101, a client server device 102, and a server computing system 125 (e.g., via a network). In some embodiments, request processing node 301 can be a part of the client server device 102.

The request processing node 301 can operate as a gateway (e.g., a hosted or an on-premises gateway), a middleware, or a sidecar for server devices 102A-B. The request processing node 301 can be connected to a user device 101, to a server computing system 125, and to a client server device 102, e.g., via one or more networks (not illustrated). In some embodiments, the request processing node 301 can be part of the client server device 102. In other embodiments, the request processing node 301 can be part of a network interface card (NIC). The request processing node 301 can include a process request pipeline 302, a process response pipeline 352, and post-process response pipeline 362. The request processing node 301 can also include security configurations 340, access configuration 342, rate limit configurations 344, rate limit map 348, and a cache 350.

Security configurations 340 can store security rules received from server computing system 125, and used by security module 312. Access configurations can store access rules received from server computing system 125 (i.e., configuration component 110), and used by access check module 314. Rate limit configurations 344 can store rate limit rules received from server computing system 125 (i.e., configuration component 110), and used by rate limit module 316. Rate limit map 348 can store available rate limit credits for each requestor. In some embodiments, rate limit map 348 can store an available rate limit corresponding to each rule in rate limit configurations 344. That is, rate limit map 348 can store the available rate limits for a requestor for each level of granularity that has a corresponding rule in rate limit configurations 344. Rate limit maps 348 can also store an overall available rate limit for each requestor. Cache 350 can store a cache of recent queries performed on client server device 102. Errors 370 can store information associated the outcomes of the operations performed at modules 304-320 (i.e., performed during access control).

The request processing node 301 can receive a request from user device 101. The request can include a query for multiple types of data sent to a single endpoint (e.g., a single API or URL). The request processing node 301 can process the request via process request pipeline 302. In some embodiments, process request pipeline 302 can perform at least some of the same functions as access control component 103 of FIGS. 1, 2.

Process request pipeline 302 can include a profile access module 304, a request sanitation module 306, a request parsing module 308, a request analysis module 310, a security module 312, an access check module 314, a rate limit module 316, a violations module 218, and/or a cache module 320.

Profile access module 304 can identify a user profile associated with the user device 101 from which the request was received. The user can also be referred to as the requestor herein. In some embodiments, the request can include a user ID identifying the user profile. In some embodiments, the user profile can be identified based on the user device 101 from which the request was received. The identified user profile can specify, for example, a role (or set of roles) assigned to the user. The profile access module 304 can identify the role(s) that match the received request. In some embodiments, the profile access module 304 can identify the IP address the user device 101 from which the request was received, and can identify the user profile using the IP address.

Request sanitation module 306 can sanitize the received request by removing any identified private or sensitive data in the request, such as passwords, social security numbers, credit card information, email addresses, addresses, etc.

Request parsing module 308 can parse the received request. Request parsing module 308 can identify the query string included in the request and can parse it into objects that are related to each other, in a format that can be processed. For example, request parsing module 308 can parse the query into an abstract syntax tree. Request parsing module 308 can identify different parts of the query. A part of the query can be the objects being requested, the types of data being requested, the path of the data being requested, the fields being requested, etc.

Request analysis module 310 can analyze the parsed query to determine an object (e.g., a numerical object) for the query. The object can represent an estimated score for fulfilling the request in embodiments. In some embodiments, the estimated score can be based on the different parts of the query. For example, the estimated score can be based on the number of branches in a path of the syntax tree, the number of objects being requested, the number of each type of data being requested, the number of each field being requested, etc. The estimated score can include one overall number, and/or can include multiple sub-scores for different parts of the query.

Security module 312 can provide safeguards to the server device 102 by limiting queries based on the depth of the query. Security module 312 can access security configurations 340. In some embodiments, security configurations 340 can be established via the security configuration component 120 of FIG. 1. Security configurations 340 can include limitations that provide additional security for client server device 102. In some embodiments, security module 312 can prevent a query from progressing to the server device 102 based on the shape or style of the query. For example, security module 312 can limit queries to paths of four-fields deep. The security policies can be received from a client and configured in security configuration component 120 of FIG. 1. Security module 312 can identify a part (or parts) of the query that do not satisfy the security configurations 340, and can block the identified part(s) from reaching the client server device 102 by removing the part(s) from the query. Security module 312 can store information related to the identified part(s) in errors 370.

Access check module 314 can apply rules on particular fields in the database based on access configurations 342. Access configurations 342 can include rules that limit access to certain parts of a query (e.g., certain fields, certain data types, and/or certain data access path) based on the requestor's profile. As an illustrative example, certain data access paths can be restricted to requestors that have an administrator role. The access check module 314 can remove parts of the query for which the requestor does not have access. The access check module 314 can add information about the removed parts to errors 370.

Rate limiting module 316 can identify the rate limit configurations 344 that are associated with the parts of the query identified by request parsing module 308. The rate limit configurations 344 can include one or more rules for each part of the query. The rate limit configurations 344 can specify the amount of credits needed to satisfy each part of the query. Rate limiting module 316 can use the rate limit map 348 to determine whether the requestor has sufficient credits to fulfill each part of the query. If not, the rate limiting module 316 can block the query from progressing. In some embodiments, rate limiting module 316 can block the parts of the query for which the requestor does not have sufficient credits to fulfill, while permitting other parts of the query for which the requestor does have sufficient credits to fulfill. That is, if the requestor has sufficient credits to fulfill half of the query, the rate limiting module 316 can remove half of the query and store associated information in errors 370.

Violations module 318 can determine whether the request is attempting to inject information into variable fields in the data store (e.g., data store 130A,B). Violations module 318 can block such inject-style attacks. Cache module 320 can determine whether the requested data is stored in cache 350. If so, cache module 320 can retrieve the cached data from cache 350, and return the cached data to the user device 101. Cache module 320 can help reduce the load on client server device 102 by not performing the same query multiple times.

Once the response passes through the process request pipeline 302, a query is sent to client server device 102. The query sent to client server device 102 may not be the same as the query in the request received from user device 101. That is, modifications may be made the query based on the outcomes of modules 304-320. In some embodiments, a second query is generated based on the outcomes of module 304-320. The second query can include only the accessible and valid parts of the query.

In some embodiments, if the request fails at least one of the modules 304-320 in the process request pipeline 302, the request may not be sent to client server device 102. In such instances, the request processing node 301 can send a notification to user device 101. The notification can include an error message, which can identify at which step(s) the request failed.

In some embodiments, the error message can be a generic error message that does not provide additional information about at which step(s) the request failed. In some embodiments, even though a query was not sent to data store 130, the request can pass through the processing response pipeline 352 and/or the post-process response pipeline 362.

Client server device 102 can process the received query (e.g., the second query) and return a response, e.g., in the form of a JSON file. Request processing node 301 can receive a response to the query from client server device 102. The request processing node 301 can process the response via process response pipeline 352 and/or post-processing response pipeline 362.

The process response pipeline 352 can include a personally identifying information (PII) check module 354, an append module 256, and/or a reduct module 258. The PII check module 354 can identify personally identifying information in the response received from client server device 102, and can remove the identified personally identifying information. Examples of personally identifying information can include social security numbers, credit card numbers, driver's license numbers, taxpayer identification numbers, etc. In some embodiments, the client can identify which types of personally identifying information is to be removed from the response.

The append module 356 can append errors (e.g., stored in errors 370) that resulted from the operations performed at modules 304-320. That is, if the query was modified based on one of the modules 304-320, information regarding the modification is appended to the response. For example, if the security module 312 determined that one part of the query exceeded the security configurations 340 and blocked that part of the query from being sent to client server device 102 (i.e., that part of the query was not included in the second query sent to client server device 102), append module 356 can append, to the response, information regarding the removal of the blocked part of the query. As another example, if access check module 314 determined that the requestor does not have access to a particular data access path identified in the query, the append module 356 can append, to the response, information regarding the particular data access path inaccessible to the requestor. As another example, if rate limit module 316 determined that the requestor did not have sufficient credits to fulfill one part of the query, the append module 356 can append, to the response, information regarding that part of the query. The information can include, for example, the part of the query omitted from the second query sent to the client server device 102, the reason the part of the query was omitted, and/or error codes generated from the request.

The reduct module 358 can identify and remove information sent by client server device 102 that is not intended to reach user device 101, such as debug data. In some embodiments, the information removed from response can be based on input received from the client server device 102 (i.e., clients can specify the information to identify and remove from a generated response). Once the response has passed through process response pipeline 352, the request processing node 301 can send the updated response (i.e., the appended and/or reducted version of the response) to user device 101. The response can be further processed through post-process response pipeline 362.

The post-process response pipeline 362 can include an update rate limit module 364, an analysis module 366, and/or an update cache module 368. The update rate limit module 364 can update the rate limit map 348 based on a factor corresponding to the rate score. The analysis module 366 can analyze the response, e.g., to determine the size of the response and/or to determine the resources consumed in generating the response. The update cache module 368 can update cache 350 with the contents of the response.

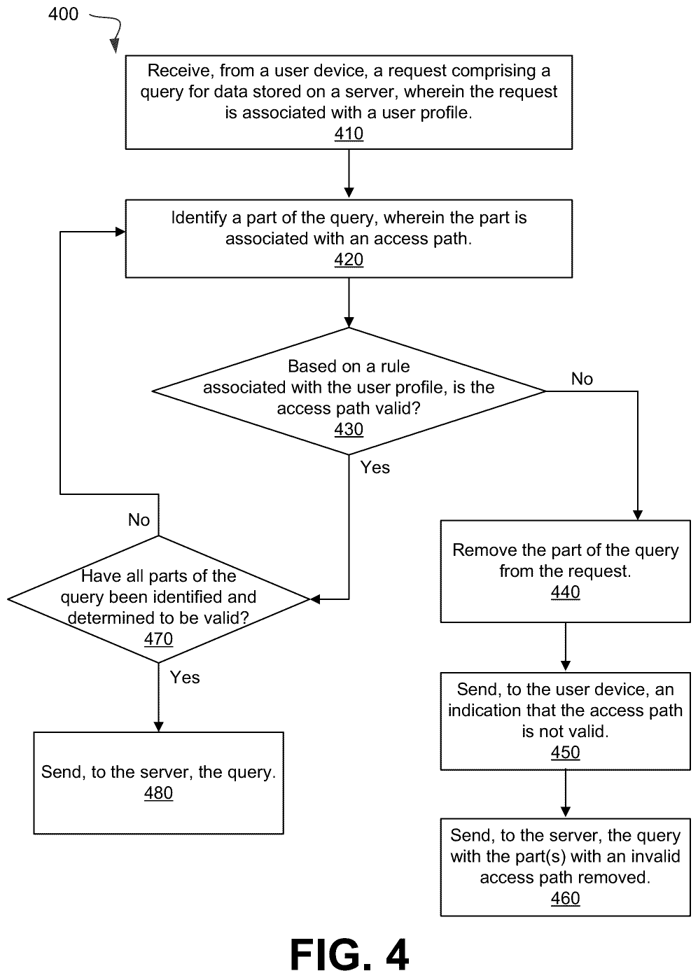

FIG. 4 is a flow diagram illustrating a method 400 for edge-based access control, in accordance with embodiments of the present disclosure. The method 400 may be performed by a processing logic that may comprise hardware (e.g., circuitry, dedicated logic, programmable logic, microcode, etc.), software (e.g., instructions run on a processing device to perform hardware simulation), or a combination thereof. In one embodiment, at least some operations of the method 400 can be performed by access control component 103 of FIG. 1. Note that the access control component 103 can perform all or parts of method 400 for multiple devices simultaneously. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, processing logic receives, from a user device (e.g., device 101A-N of FIG. 1), a request comprising a query for data stored on a server (e.g., server device 102A-B of FIG. 1). The request can be associated with a user profile. In some embodiments, processing logic can identify and remove, from the request, user data associated with the user profile (e.g., as described with regards to request sanitation module 306 of FIG. 3). For example, processing logic can identify sensitive or private data included in the request, such as passwords, or username and password combinations.

At operation 420, processing logic identifies a part of the query. The identified part of the query can be a requested data object and the corresponding data access path. In some embodiments, the identified part of the query is the data access path. In some embodiments, to identify the part of the query, processing logic can parse the query (e.g., as described with respect to parsing module 220 of FIG. 2, and/or request parsing module 308 of FIG. 3). Parsing the query can include, for example, generating a syntax tree (e.g., an abstract syntax tree) for the query. The syntax tree can include a plurality of nodes and a plurality of branches. In some embodiments, the nodes can represent data objects. The branches can represent the connections between the nodes. The branches leading to the requested data object can represent the part identified at operation 420.

At operation 430, processing logic determines whether, based on a rule associated with the user profile, the access path is valid. That is, processing logic can identify a rule that is applicable to the user profile. For example, the user profile can specify a role, and processing logic can identify the rule(s) for that role. Note that more than one rule associated with the user profile (or role) can be applied to the access path. The user profile can specify a specific user, a user type, a user role, a user group, an IP address, etc., and the processing logic can identify the rule(s) applicable to the specific user, user type, user role, user group, and/or IP address. For example, each rule can specify to which profile, user, user type, user role, user group, IP address, and/or any other category of users, the rule applies. In some embodiments, all rules can be applicable the user profile. For example, if the user profile does not specify a role, user type, user group, IP address, user, etc., processing logic can determine that all the rules are applicable to the user profile. Based on the rule(s) applicable to the user profile, the processing logic can determine whether the access path is valid. That is, the processing logic can compare the access path to the rule to determine whether the path is accessible to the user profile or not.

In some embodiments, the identified part can be include an input parameter, and the rule associated with the user profile can place a limit on the input parameter. For example, the part of the query can be a data object that can be mutated or modified, and the identified part includes an input parameter to mutate or modify the data object. The rule associated with the user profile limit the number of, and/or which parts of the object, can be mutated or modified.

Responsive to determining that, based on the rule associated with the user profile, the access path is valid, the processing logic proceeds to operation 440. At operation 440, processing logic removes the part of the query associated with the invalid access path from the request. The processing logic can then generate a second query that includes only the parts of the original query that are valid (i.e., for which the associated access path is determined to be value based on the rule(s) associated with the user profile). That is, the second query can be the first query with the invalid parts removed. At operation 460, the processing logic can send, the server (e.g., client server device 102A,B of FIG. 1), the query with the part(s) with an invalid access path removed (i.e., the second query). The processing logic can In some embodiments, responsive to determining that the access path is not valid, the processing logic can determine not to send the query to the server (i.e., the processing logic can block the query from accessing the server). Additionally, responsive to determining that the access path is invalid, at operation 450, the processing logic sends, to the user device, an indication that the access path is not valid.

Responsive to determining that the access path is valid, the processing logic proceeds to operation 470 and determines whether all parts of the query have been identified and have been determined have a valid corresponding access path. If no, the processing logic returns to operation 420 to identify another part of the query. If yes, the processing logic proceeds to operation 480, and sends, to the server, the query as it was originally received.

The processing logic receives, from the server, a response. The processing logic can append, to the response, the indication that the access path is not valid prior to sending the response to the user device.

In some embodiments, the processing logic can receive, from the user device, an introspection request to view the data stored on the server. The processing logic can determine, based on a set of rules associated with the user profile, a subset of the data that is accessible to the user profile. The set of rules can include the rule used at operation 430. The processing logic can display, on the user device, the subset of the data that is accessible to the user profile. For example, the subset of the data that is accessible to the user profile can include the accessible data paths, and/or the data objects input parameters that are available to the user profile.

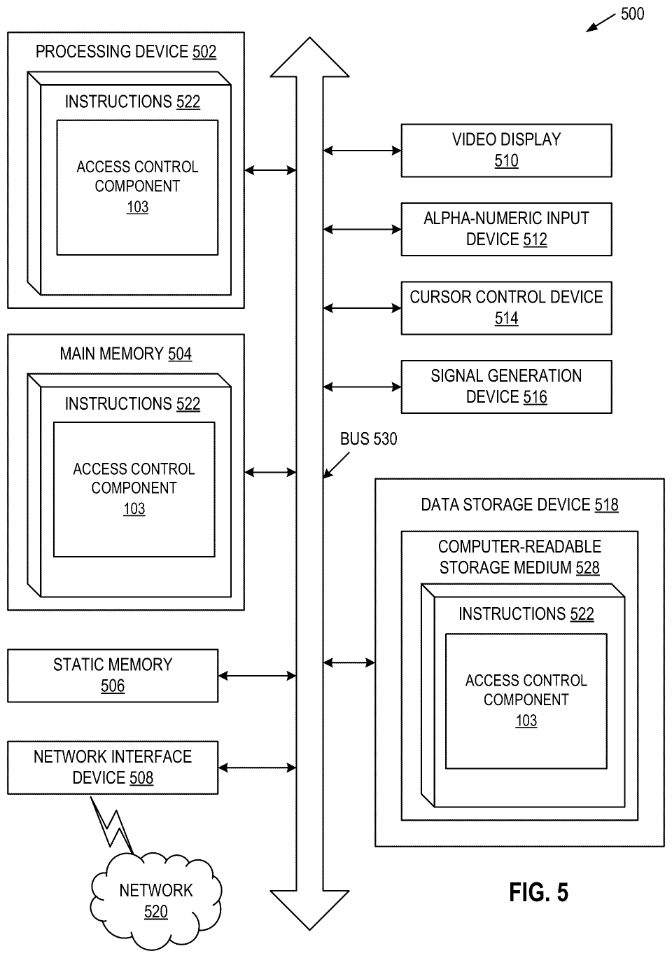

FIG. 5 illustrates a block diagram of a machine in the example form of a computing device 500 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a secondary memory (e.g., a data storage device 518), which communicate with each other via a bus 530.

Processing device 502 represents one or more general-purpose processors such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. Processing device 502 is configured to execute the processing logic (instructions 522) for performing the operations and steps discussed herein.

The computing device 500 may further include a network interface device 508 to communicate over network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a machine-readable storage medium (or more specifically a computer-readable storage medium) 528 on which is stored one or more sets of instructions 522 embodying any one or more of the methodologies or functions described herein. The instructions 522 may also reside, completely or at least partially, within the main memory 504 and/or within the processing device 502 during execution thereof by the computer system 500, the main memory 504 and the processing device 502 also constituting computer-readable storage media.

The computer-readable storage medium 528 may also be used to store an access control component 103 (as described with reference to FIGS. 1 and 2), and/or a software library containing methods that call an access control component 103. While the computer-readable storage medium 528 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies described herein. The term “computer-readable storage medium” shall accordingly be taken to include, but not be limited to, solid-state memories, and optical and magnetic media.

The modules, components and other features described herein (for example in relation to FIGS. 1-2) can be implemented as discrete hardware components or integrated in the functionality of hardware components such as ASICS, FPGAs, DSPs or similar devices. In addition, the modules can be implemented as firmware or functional circuitry within hardware devices. Further, the modules can be implemented in any combination of hardware devices and software components, or only in software.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving”, “identifying”, “determining”, “selecting”, “analyzing”, “generating”, “performing”, or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the discussed purposes, or it may comprise a general purpose computer system selectively programmed by a computer program stored in the computer system. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic disk storage media, optical storage media, flash memory devices, other type of machine-accessible storage media, or any type of media suitable for storing electronic instructions, each coupled to a computer system bus.

It is to be understood that the above description is intended to be illustrative, and not restrictive. Many other embodiments will be apparent to those of skill in the art upon reading and understanding the above description. Although the present invention has been described with reference to specific example embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A method comprising:
receiving, from a user device, a request comprising a query for data stored on a server, wherein the request is associated with a user profile;
identifying a part of the query, wherein the part is associated with an access path;
determining, based on a rule associated with the user profile, whether the access path is valid; and
responsive to determining that the access path is not valid:
removing the part of the query from the request; and
sending, to the user device, an indication that the access path is not valid.

2. The method of claim 1, further comprising:
generating a second query comprising the query with the part of the query associated with the access path that is not valid removed; and
sending, to the server, the second query.

3. The method of claim 1, further comprising:
responsive to determining that the access path is not valid, determining not to send the query to the server.

4. The method of claim 1, further comprising:
receiving, from the server, a response; and
appending, to the response, the indication that the access path is not valid prior to the sending the response to the user device.

5. The method of claim 1, wherein identifying the part of the query comprises:
generating a syntax tree for the query, wherein the syntax tree comprises a plurality of nodes and a plurality of branches, wherein a first node of the plurality of nodes represents a first type of the part, and wherein one or more of the plurality of branches represents the access path.

6. The method of claim 1, wherein the part of the query comprises an input parameter, and wherein the rule associated with the user profile places a limit on the input parameter.

7. The method of claim 1, further comprising:
receiving, from the user device, an introspection request to view the data stored on the server;
determining, based on a set of rules associated with the user profile, a subset of the data that is accessible to the user profile, wherein the set of rules comprises the rule; and
displaying, on the user device, the subset of the data that is accessible to the user profile.

8. A system comprising:
a memory; and
a processing device coupled to the memory, the processing device to:
receive, from a user device, a request comprising a query for data stored on a server, wherein the request is associated with a user profile;
identify a part of the query, wherein the part is associated with an access path;
determine, based on a rule associated with the user profile, whether the access path is valid; and
responsive to determining that the access path is not valid:
remove the part of the query from the request; and
send, to the user device, an indication that the access path is not.

9. The system of claim 8, wherein the processing device is further to:
generate a second query comprising the query with the part of the query associated with the access path that is not valid removed; and
send, to the server, the second query.

10. The system of claim 8, wherein the processing device is further to:
responsive to determining that the access path is not valid, determine not to send the query to the server.

11. The system of claim 8, wherein the processing device is further to:
receive, from the server, a response; and
append, to the response, the indication that the access path is not valid prior to the sending the response to the user device.

12. The system of claim 8, wherein to identify the part of the query, the processing device is further to:
generate a syntax tree for the query, wherein the syntax tree comprises a plurality of nodes and a plurality of branches, wherein a first node of the plurality of nodes represents a first type of the part, and wherein one or more of the plurality of branches represents the access path.

13. The system of claim 8, wherein the part of the query comprises an input parameter, and wherein the rule associated with the user profile places a limit on the input parameter.

14. A non-transitory computer readable storage medium comprising instructions that, when executed by a processing device, cause the processing device to perform operations comprising:
receiving, from a user device, a request comprising a query for data stored on a server, wherein the request is associated with a user profile;
identifying a part of the query, wherein the part is associated with an access path;
determining, based on a rule associated with the user profile, whether the access path is valid; and
responsive to determining that the access path is not valid:
removing the part of the query from the request; and
sending, to the user device, an indication that the access path is not valid.

15. The non-transitory computer readable storage medium of claim 14, the operations further comprising:
generating a second query comprising the query with the part of the query associated with the access path that is not valid removed; and
sending, to the server, the second query.

16. The non-transitory computer readable storage medium of claim 14, the operations further comprising:
responsive to determining that the access path is not valid, determining not to send the query to the server.

17. The non-transitory computer readable storage medium of claim 14, the operations further comprising:
receiving, from the server, a response; and
appending, to the response, the indication that the access path is not valid prior to the sending the response to the user device.

18. The non-transitory computer readable storage medium of claim 14, wherein identifying the part of the query comprises:
generating a syntax tree for the query, wherein the syntax tree comprises a plurality of nodes and a plurality of branches, wherein a first node of the plurality of nodes represents a first type of the part, and wherein one or more of the plurality of branches represents the access path.

19. The non-transitory computer readable storage medium of claim 14, wherein the part of the query comprises an input parameter, and wherein the rule associated with the user profile places a limit on the input parameter.

20. The non-transitory computer readable storage medium of claim 14, the operations further comprising:
receiving, from the user device, an introspection request to view the data stored on the server;
determining, based on a set of rules associated with the user profile, a subset of the data that is accessible to the user profile, wherein the set of rules comprises the rule; and
displaying, on the user device, the subset of the data that is accessible to the user profile.
